(19) United States
(12) Patent Application Publication
(10) Pub. No.: US 2010/0050826 A1
(43) Pub. Date: Mar. 4, 2010

(54) Oil filter wrench

(76) Inventor: Chen Jun Fan, Taichung City (TW)

Correspondence Address: Chen Jun Fan, 5F.-2, No.212, Sec.1, Wunsin Rd., Taichung City, 408, TW

(21) Appl. No.: 12/288,312

(22) Filed: Oct. 20, 2008

(30) Foreign Application Priority Data
Aug. 28, 2008 (TW) 097215452

(51) Int. Cl. B25B 7/04

(52) U.S. Cl. 81/386

(57) ABSTRACT

An oil filter wrench in accordance with the present invention comprises a first handle and a second handle pivotally jointed together by a pivot shaft. A first jaw and a second jaw are respectively pivotally connected to a front end of the first handle and the second handle. The angle formed by the first/second handle and the first/second jaw can be adjusted step by step.

### BACKGROUND OF THE INVENTION

1. Field of the Invention

The present invention relates to a wrench, and more particularly to an oil filter wrench for use in a restricted space.

2. Description of Related Art

An oil filter wrench is a type of hand tools for securely clamping an outer periphery of the oil filter and rotating the oil filter to detach the oil filter from an engine chamber. The conventional oil filter wrench usually includes two handles pivotally joint to each other. Each has a grip formed on a first end and a toothed curved jaw formed on a second end. The corresponding curved jaws are provided to securely clamp the oil filter for rotating and detaching the oil filter. As well known, the engine chamber contains complicated structures of the vehicle such that the surplus space is limited and the handles of the conventional oil filter wrench is fixed. As a result, the operating margin of the conventional oil filter wrench is limited.

The present invention has arisen to mitigate and/or obviate the disadvantages of the conventional oil filter wrench.

### SUMMARY OF THE INVENTION

The main objective of the present invention is to provide an improved oil filter wrench that can be conveniently operated in an restricted area.

To achieve the objective, the oil filter wrench in accordance with the present invention comprises a first handle and a second handle pivotally jointed together by a pivot shaft. A first jaw and a second jaw are respectively pivotally connected to a front end of the first handle and the second handle.

The first handle includes a peanut-shaped through hole defined therein and a first grip formed on a rear end thereof. The first handle includes two parallel ears extending from the front end and a receiving space defined between the two ears. Each ear has a central hole defined therein and extending therethrough. Two bores are defined in a corresponding one of the two ears and diametrically corresponding to each other relative to the central hole in the corresponding ear. Each bore has a steel ball and a spring sequentially adjustably mounted therein, and each steel ball partially extends out of the bore.

The second handle includes a through hole defined therein and a second grip formed on a rear end thereof. The second handle includes two parallel ears extending from a front end thereof and a receiving space defined between the two ears of the second handle. Each ear of the second handle has a central hole defined therein and extending therethrough. Two bores are defined in a corresponding one of the two ears of the second handle and diametrically corresponding to each other relative to the central hole in the corresponding ear of the second handle. Each bore in the second handle has a steel ball and a spring sequentially adjustably mounted therein, and each steel ball partially extending out of the bore in the second handle.

The first jaw is formed with an inner concave side adapted to correspond to a shape/periphery of an oil filter and includes multiple clamping teeth extending from the inner concave side for securely clamping the oil filter during operation. An enlarged connecting portion is formed on a rear end of the first jaw and pivotally sandwiched between the two parallel ears of the first handle. The connecting portion is formed with a smooth lateral side corresponding to the receiving space in the first handle. The connecting portion has two opposite sides each formed with an abutting face. A through hole is centrally defined in the connecting portion and communicates with the two opposite abutting face. Multiple indentations are respectively defined in a corresponding one of the two abutting faces and surround the through hole in the first jaw. The multiple indentations selectively communicate with the two bores in the corresponding ear of the first handle for partially receiving the steel balls in the two bores in the first handle to selectively positioning the first jaw due to the restitution force of the two springs of the first handle.

The second jaw is formed with an inner concave side adapted to correspond to a shape/periphery of the oil filter and includes multiple clamping teeth extending from the inner concave side for securely clamping the oil filter during operation. An enlarged connecting portion is formed on a rear end of the second jaw and pivotally sandwiched between the two parallel ears of the second handle. The connecting portion of the second jaw is formed with a smooth lateral side corresponding to the receiving space in the second handle. The connecting portion of the second jaw has two opposite sides each formed with an abutting face. A through hole is centrally defined in the connecting portion of the second jaw and communicates with the two opposite abutting face of the second jaw. Multiple indentations are respectively defined in a corresponding one of the two abutting faces and surround the through hole in the second jaw. The multiple indentations selectively communicates with the two bores in the corresponding ear of the second handle for partially receiving the steel balls in the two bores in the second handle to selectively positioning the second jaw due to the restitution force of the two springs of the second handle.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of an oil filter wrench in accordance with the present invention;

FIG. 2 is an exploded perspective view of a pair of jaws of the oil filter wrench in FIG. 1;

FIG. 3 is a perspective view of the oil filter wrench in accordance with the present invention;

FIG. 4 is a cross-sectional view of the oil filter wrench along line A-A in FIG. 3;

FIG. 5 is a cross-sectional view of the oil filter wrench along line B-B in FIG. 3;

FIG. 6 is an operational view of the oil filter wrench in accordance with the present invention;

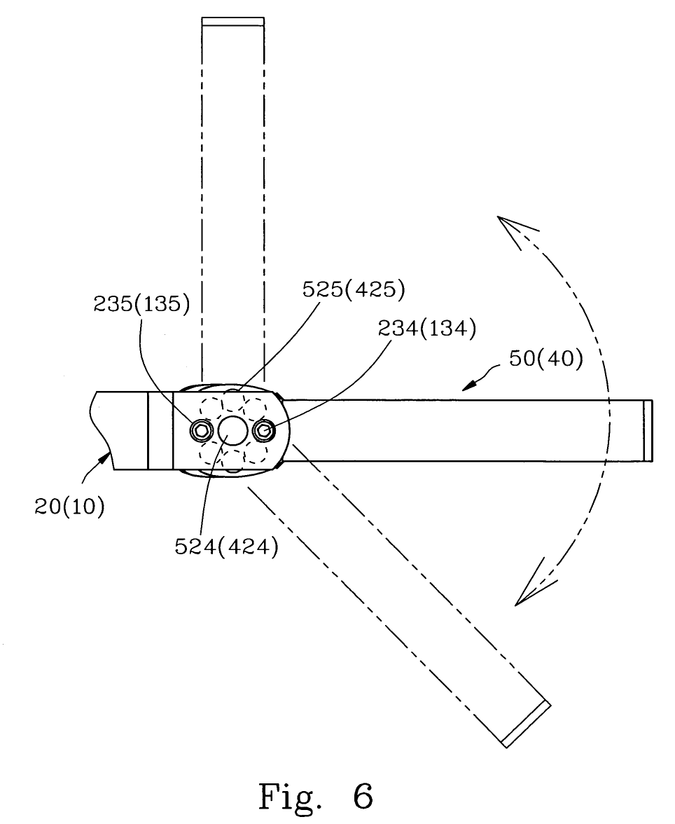

FIG. 7 is a first schematic view of the oil filter wrench in accordance with the present invention; and

FIG. 8 is a second schematic view of the oil filter wrench in accordance with the present invention.

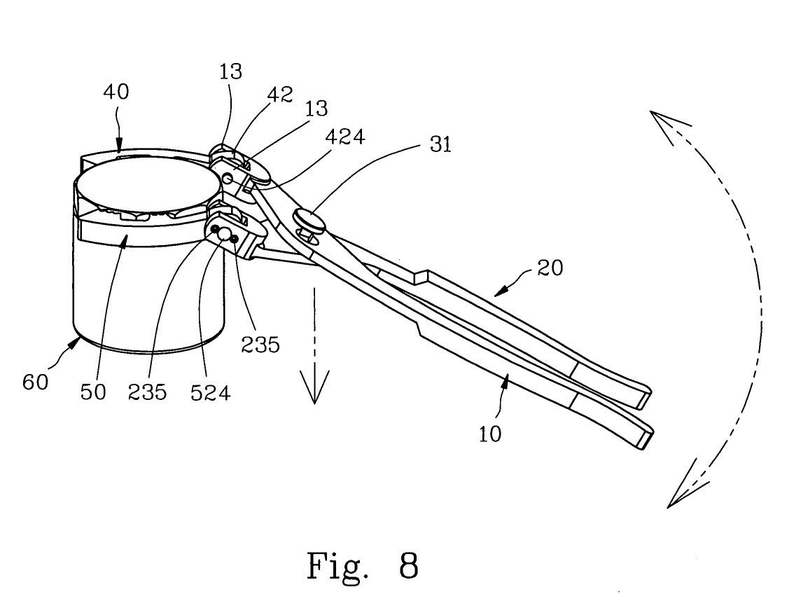

### DETAILED DESCRIPTION OF THE INVENTION

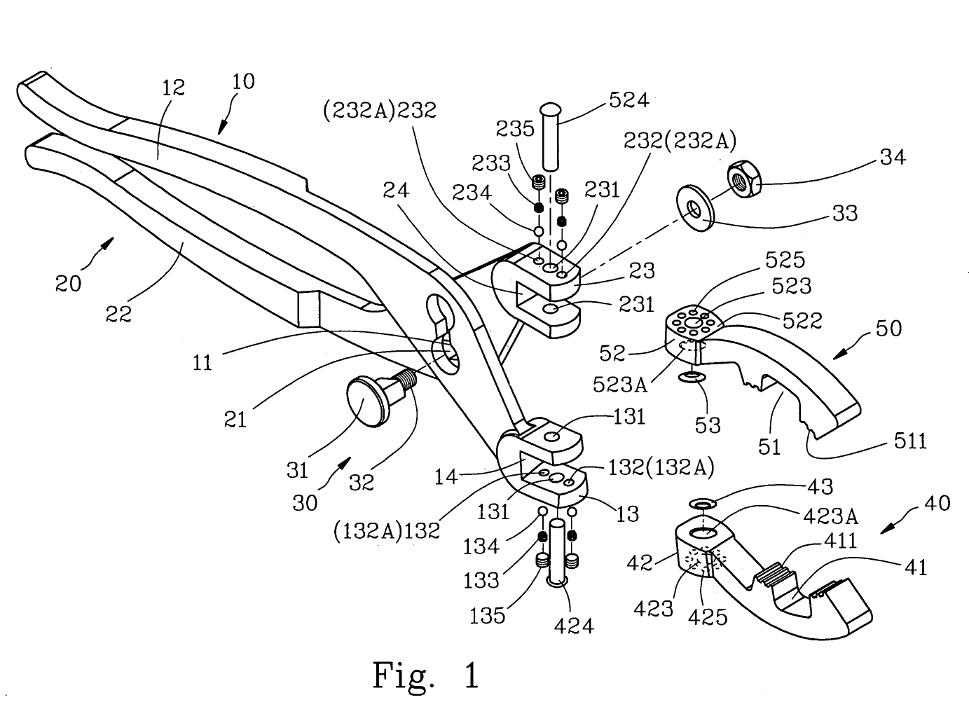

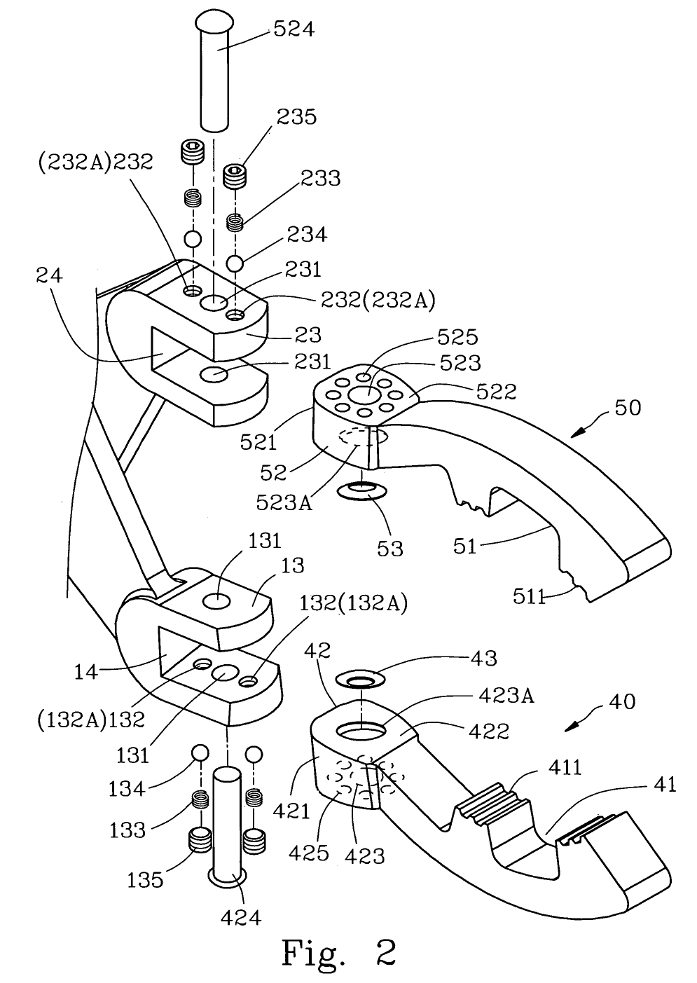

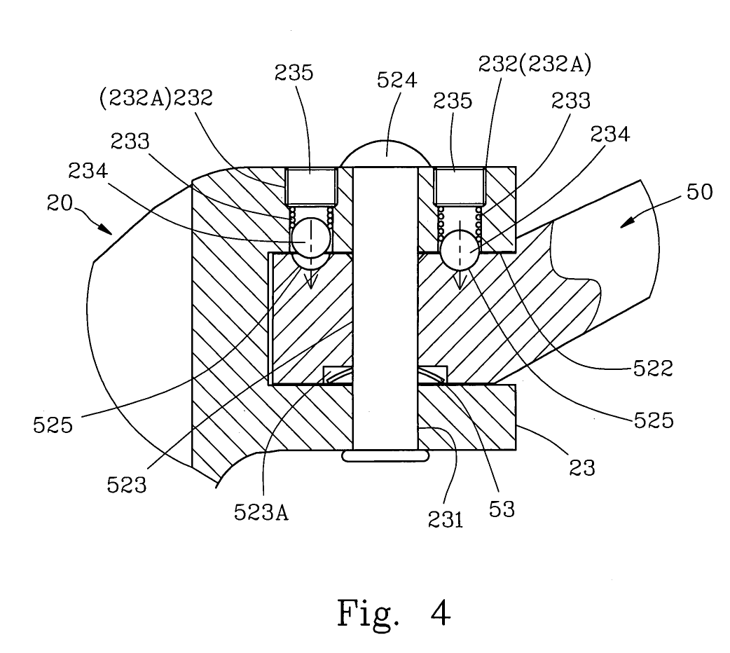

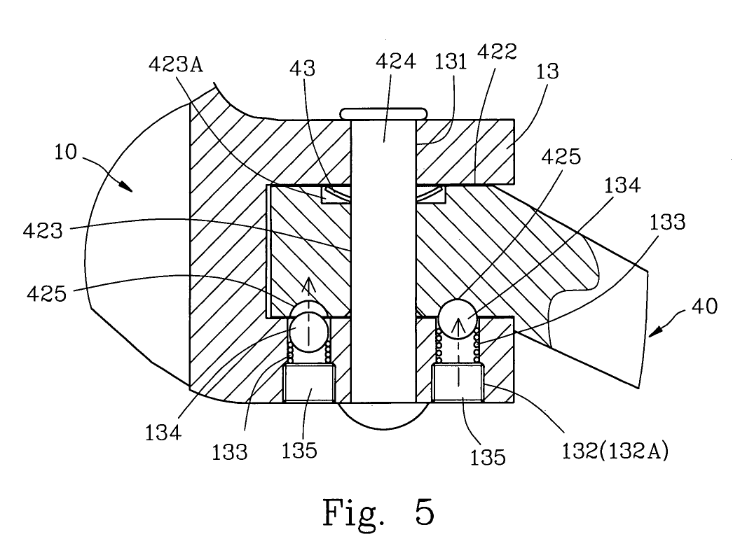

Referring to the drawings and initially to FIGS. 1-5, an oil filter wrench is provided to detach/mount an oil filter. The oil filter wrench in accordance with the present invention comprises a first handle (10) and a second handle (20) pivotally jointed together by a pivot shaft (30). A first jaw (40) and a second jaw (50) are respectively pivotally connected to a front end of the first handle (10) and the second handle (20).

The first handle (10) includes a peanut-shaped through hole (11) defined therein and a first grip (12) formed on a rear end of the first handle (10). The first handle (10) includes two parallel ears (13) extending from the front end and a receiving space (14) is defined between the two ears (13). Each ear (13) has a central hole (131) defined therein and extending therethrough. Two bores (132) is defined in a corresponding one of the two ears (13) and diametrically corresponding to each other relative to the central hole (131) in the corresponding ear (13). Each bore (132) has a steel ball (134) and a spring (133) sequentially mounted therein, and the steel ball (134) partially extending out of the bore (132). Each bore (132) has an inner thread (132A) and an adjust bolt (135) is screwed into each of the bores (132) along the inner thread (132A) to prevent the steel ball (134) and the spring (133) from detaching from the bore (132) and adjusting the torsion of the spring (133).

The second handle (20) has a structure similar to that of the first handle (10). The second handle (20) includes a through hole (21) defined therein and a second grip (22) formed on a rear end of the second handle (20). The second handle (20) includes two parallel ears (23) extending from the front end and a receiving space (24) is defined between the two ears (23). Each ear (23) has a central hole (231) defined therein and extending therethrough. Two bores (232) is defined in a corresponding one of the two ears (23) and diametrically corresponding to each other relative to the central hole (231) in the corresponding ear (23). Each bore (232) has a steel ball (234) and a spring (233) sequentially mounted therein, and the steel ball (234) partially extending out of the bore (232). Each bore (232) has an inner thread (232A) and an adjust bolt (235) is screwed into each of the bores (232) along the inner thread (232A) to prevent the steel ball (234) and the spring (233) from detaching from the bore (232) and adjusting the torsion of the spring (233).

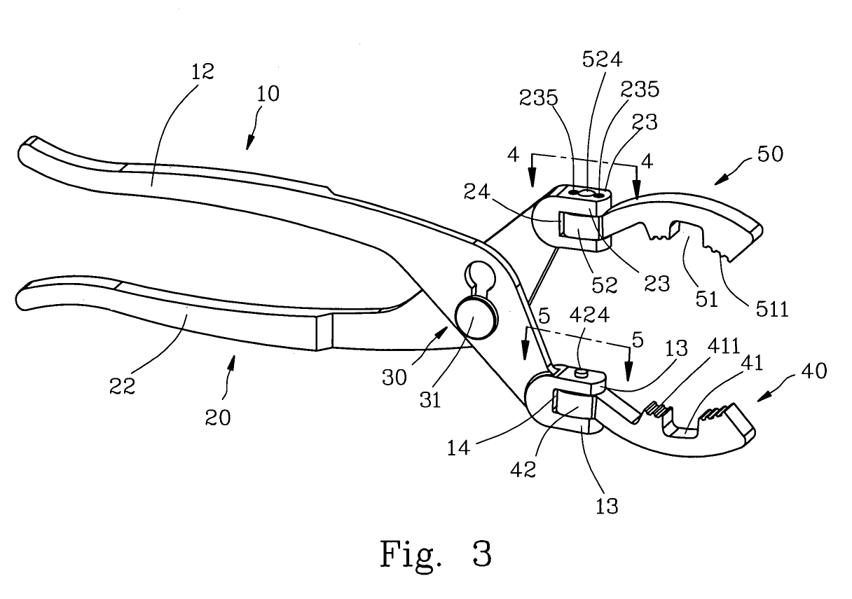

With reference to FIGS. 1 and 3, the pivot shaft (30) includes a head (31) and a threaded stub (32) centrally extending from the head (31). A washer (33) is sleeved on the threaded stub (32) and a nut (34) is screwed onto the threaded stub (32) to pivotally jointed together the first handle (10) and the second handle (20) after the threaded stub (32) sequentially extending the peanut-shaped through hole (11) in the first handle (10) and through hole (21) in the second handle (20).

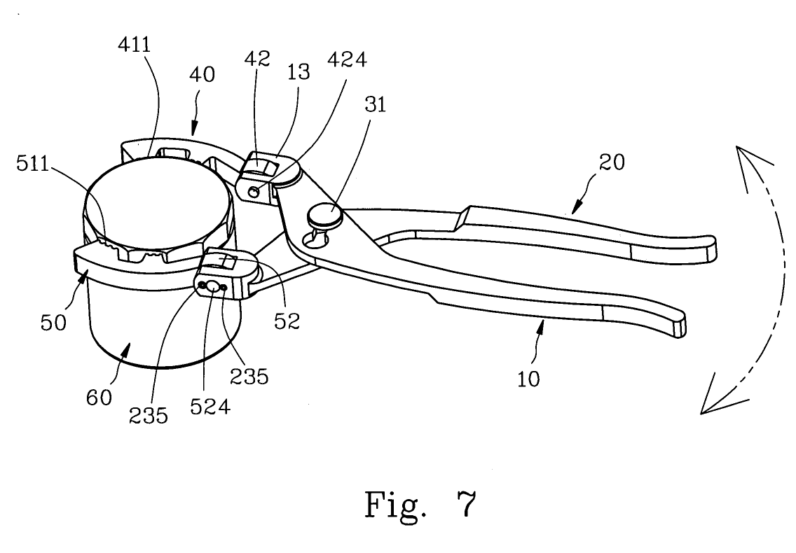

With reference to FIGS. 1-2 and 7, the first jaw (40) is formed with an inner concave side (41) corresponding to a shape/periphery of the oil filter (60) and includes multiple clamping teeth (411) extending from the inner concave side (41) for securely clamping the oil filter (60) during operation. An enlarged connecting portion (42) is formed on a rear end of the first jaw (40) and pivotally sandwiched between the two parallel ears (13) of the first handle (10). The connecting portion (42) is formed with a smooth lateral side (421) corresponding to the receiving space (14). The connecting portion (42) has two opposite sides each formed with an abutting face (422). A through hole (423) is centrally defined in the connecting portion (42) and communicating with the two opposite abutting face (422). Eight indentations (425) are respectively defined in a corresponding one of the two abutting faces (422) and surround the through hole (423). The eight indentations (425) selectively communicate with the two bores (132) in the corresponding ear (13) of the first handle (10) for partially receiving the steel balls (134) in the two bores (132) to selectively positioning the first jaw (40) due to the restitution force of the two springs (133). The through hole (423) has an enlarged portion (423A) defined in one end thereof opposite to the indentations (425) and a resilient washer (43) is mounted in the enlarged portion (423A) for promoting the connection between the first jaw (40) and the first handle (10).

With reference to FIGS. 1-2 and 7, the second jaw (50) has a structure the same as that of the first jaw (40). The second jaw (50) is formed with an inner concave side (51) corresponding to a shape/periphery of the oil filter (60) and includes multiple clamping teeth (511) extending from the inner concave side (51) for securely clamping the oil filter (60) during operation. An enlarged connecting portion (52) is formed on a rear end of the second jaw (50) and pivotally sandwiched between the two parallel ears (23) of the second handle (20). The connecting portion (52) is formed with a smooth lateral side (521) corresponding to the receiving space (24). The connecting portion (52) has two opposite sides each formed with an abutting face (522). A through hole (523) is centrally defined in the connecting portion (52) and communicating with the two opposite abutting face (522). Eight indentations (525) are respectively defined in a corresponding one of the two abutting faces (522) and surround the through hole (523). The eight indentations (525) selectively communicate with the two bores (232) in the corresponding ear (23) of the second handle (20) for partially receiving the steel balls (234) in the two bores (232) to selectively positioning the second jaw (50) due to the restitution force of the two springs (233). The through hole (523) has an enlarged portion (523A) defined in one end thereof opposite to the indentations (525) and a resilient washer (53) is mounted in the enlarged portion (523A) for promoting the connection between the second jaw (50) and the second handle (20).

With reference to FIG. 3 that show a perspective view of an oil filter wrench in accordance with the present invention containing the elements, as described hereinbefore. When operating, the distance between the first grip (12) and the second grip (22) is enlarged such that the first jaw (40) and the second jaw (50) are distanced from each other for containing the oil filter (60). The first grip (12) and the second grip (22) are securely held to make the first jaw (40) and the second jaw (50) securely clamping and rotating the oil filter (60) to tighten/loose the oil filter (60). In addition, the first handle (10) and the second handle (20) are respectively pivotally connected to the first jaw (40) and the second jaw (50) such that the angle formed by the first/second handle (10/20) and the first/second jaw (40/50) is adjustable, and the friction between the first/second handle (10/20) and the first/second jaw (40/50) is adjustable relative to the tension springs (133/233) due to the position of the adjust bolts (135/235).

As described above, the oil filter wrench in accordance with the present invention has an adjustable angle formed by the first/second handle (10/20) and the first/second jaw (40/50) such that the oil filter wrench can be conveniently operated in a restricted area, such as in the engine chamber. Furthermore, the user can adjust the adjust bolts (135/235) to make the springs (133/233) more securely abutting the steel balls (134/234) when the oil filter wrench has used for a period of time and the steel balls (134/234) are worn out.

Although the invention has been explained in relation to its preferred embodiment, it is to be understood that many other possible modifications and variations can be made without departing from the spirit and scope of the invention as hereinafter claimed.

What is claimed is:

1. An oil filter wrench comprising:
a first handle including a peanut-shaped through hole defined therein and a first grip formed on a rear end thereof, the first handle including two parallel ears extending from the front end and a receiving space defined between the two ears, each ear having a central hole defined therein and extending therethrough, two bores defined in a corresponding one of the two ears and diametrically corresponding to each other relative to the central hole in the corresponding ear, each bore has a steel ball and a spring sequentially adjustably mounted therein, and each steel ball partially extending out of the bore;
a second handle pivotally jointed together to the first handle, the second handle including a through hole defined therein and a second grip formed on a rear end thereof, the second handle including two parallel ears extending from a front end thereof and a receiving space defined between the two ears of the second handle, each ear of the second handle having a central hole defined therein and extending therethrough, two bores defined in a corresponding one of the two ears of the second handle and diametrically corresponding to each other relative to the central hole in the corresponding ear of the second handle, each bore in the second handle having a steel ball and a spring sequentially adjustably mounted therein, and each steel ball partially extending out of the bore in the second handle;
a pivot shaft sequentially extending peanut-shaped through hole in the first handle and the through hole in a middle of the second handle for pivotally mounting the first handle and the second handle;
a first jaw pivotally connected to the front end of the first handle, the first jaw formed with an inner concave side adapted to correspond to a shape/periphery of an oil filter and including multiple clamping teeth extending from the inner concave side for securely clamping the oil filter during operation, an enlarged connecting portion formed on a rear end of the first jaw and pivotally sandwiched between the two parallel ears of the first handle, the connecting portion formed with a smooth lateral side corresponding to the receiving space in the first handle, the connecting portion having two opposite sides each formed with an abutting face, a through hole centrally defined in the connecting portion and communicating with the two opposite abutting face, multiple indentations respectively defined in a corresponding one of the two abutting faces and surround the through hole in the first jaw, the multiple indentations selectively communicating with the two bores in the corresponding ear of the first handle for partially receiving the steel balls in the two bores in the first handle to selectively positioning the first jaw due to the restitution force of the two springs of the first handle; and
a second jaw pivotally connected to the front end of the second handle, the second jaw formed with an inner concave side adapted to correspond to a shape/periphery of the oil filter and including multiple clamping teeth extending from the inner concave side for securely clamping the oil filter during operation, an enlarged connecting portion formed on a rear end of the second jaw and pivotally sandwiched between the two parallel ears of the second handle, the connecting portion of the second jaw formed with a smooth lateral side corresponding to the receiving space in the second handle, the connecting portion of the second jaw having two opposite sides each formed with an abutting face, a through hole centrally defined in the connecting portion of the second jaw and communicating with the two opposite abutting face of the second jaw, multiple indentations respectively defined in a corresponding one of the two abutting faces and surround the through hole in the second jaw, the multiple indentations selectively communicating with the two bores in the corresponding ear of the second handle for partially receiving the steel balls in the two bores in the second handle to selectively positioning the second jaw due to the restitution force of the two springs of the second handle.

2. The oil filter wrench as claimed in claim 1, wherein the each bore in the first handle and the second handle has an inner thread and an adjust bolt is screwed into each of the bores along the inner thread to prevent the steel balls and the springs from detaching from the bore and adjusting the torsion of the springs.

3. The oil filter wrench as claimed in claim 1, wherein the through hole in each of the connecting portions of the first jaw and the second jaw has an enlarged portion defined in one end thereof opposite to the indentations and a resilient washer is mounted in each of the enlarged portions for promoting the connection between the first/second handle and the first/second jaw.
